(19) United States
(12) Patent Application Publication
(10) Pub. No.: US 2022/0082665 A1
(43) Pub. Date: Mar. 17, 2022

(54) RANGING APPARATUS AND METHOD FOR CONTROLLING SCANNING FIELD OF VIEW THEREOF

(71) Applicant: SZ DJI TECHNOLOGY CO., LTD., Shenzhen (CN)

(72) Inventors: Yalin CHEN, Shenzhen (CN); Shuai DONG, Shenzhen (CN); Xiaoping HONG, Shenzhen (CN)

(21) Appl. No.: 17/456,624

(22) Filed: Nov. 26, 2021

Related U.S. Application Data
(63) Continuation of application No. PCT/CN2019/088782, filed on May 28, 2019.

(51) Int. Cl. G01S 7/481; G02B 26/10; G01S 17/10

(52) U.S. Cl. CPC G01S 7/4817; G01S 17/10; G02B 26/10

(57) ABSTRACT

A method for controlling a scanning field of view (FOV) of a ranging apparatus includes emitting a light pulse sequence, changing the light pulse sequence to exit at different direction via at least three optical elements, wherein controlling the scanning FOV by controlling the at least three optical elements including at least one of controlling at least one of a scan patterns, a position, or a scanning density of the scanning FOV by controlling rotation speeds of the at least three optical elements, and/or controlling an extension direction of the scanning FOV by controlling initial phases of the at least three optical elements.

### CROSS-REFERENCE TO RELATED APPLICATION

This application is a continuation of International Application No. PCT/CN2019/088782, filed May 28, 2019, the entire content of which is incorporated herein by reference.

### TECHNICAL FIELD

The present disclosure relates to the field of ranging technology and, more particularly, to a ranging apparatus and method for controlling a scanning field of view thereof.

### BACKGROUND

LIDAR and laser ranging are perception systems for perceiving the outside world, which can obtain spatial distance information at emission direction. The principle is that a laser pulse signal is emitted to the outside, then the reflected pulse signals are detected. The time difference between the transmission and reception may be used to determine a distance between a ranging apparatus and a detection object. Nowadays, a pattern of the ranging apparatus in the scan range is relatively simple, and scan density cannot be changed. Although it is possible to increase the coverage area of a light spot by adjusting a shape of a light source and to obtain a large field of view (FOV) in a certain direction by scanning two separate dimensions, those measures have high requirements for aperture sizes of the light source and scan device, a complicated control system, and a limited scan range. To obtain a large FOV, the overall cost will also increase. The scan range of the ranging apparatus in the existing technologies cannot meet the needs of various applications, which is not conducive to wide application.

### SUMMARY

In accordance with the disclosure, there is provided a method for controlling a scanning field of view (FOV) of a ranging apparatus includes emitting a light pulse sequence, changing the light pulse sequence to exit at different direction via at least three optical elements, wherein controlling the scanning FOV by controlling the at least three optical elements including at least one of controlling at least one of a scan patterns, a position, or a scanning density of the scanning FOV by controlling rotation speeds of the at least three optical elements, and/or controlling an extension direction of the scanning FOV by controlling initial phases of the at least three optical elements.

Also in accordance with the disclosure, there is provided a ranging apparatus includes an emission circuit configured to emit a light pulse sequence, at least three optical elements configured to change transmission directions of the light pulse sequence, and a control circuit configured to control a scanning field of view (FOV) by performing at least one of controlling at least one of a scan pattern, a position, or a scanning density by controlling rotation speeds of the at least three optical elements. The control circuit is also configured to control an extension direction of the scanning FOV by controlling the initial phases of the at least three optical elements.

### BRIEF DESCRIPTION OF THE DRAWINGS

FIG. 1 is a schematic structural diagram showing a ranging apparatus according to some embodiments of the present disclosure.

FIG. 2 is a schematic diagram showing the ranging apparatus with a co-axial optical path according to some embodiments of the present disclosure.

FIG. 3 is a schematic diagram showing a first scanning field of view (FOV) according to some embodiments of the present disclosure.

FIG. 4 is a schematic diagram showing a third scanning FOV according to some embodiments of the present disclosure.

FIG. 5 is a schematic diagram showing a fourth scanning FOV according to some embodiments of the present disclosure.

FIG. 6 is a schematic diagram showing a fifth scanning FOV according to some embodiments of the present disclosure.

FIG. 7 is a schematic diagram showing a sixth scanning FOV according to some embodiments of the present disclosure.

FIG. 8 is a schematic diagram showing a seventh scanning FOV according to some embodiments of the present disclosure.

FIG. 9 is a schematic diagram showing an eighth scanning FOV according to some embodiments of the present disclosure.

FIG. 10 is a schematic diagram showing an example when a difference between an initial phase of a second optical element and an initial phase of a first optical element is 0 according to some embodiments of the present disclosure.

FIG. 11 is a schematic diagram showing an example when the difference between the initial phase of the second optical element and the initial phase the first optical element is π/2 according to some embodiments of the present disclosure.

FIG. 12 is a schematic diagram showing an example when the difference between the initial phase of the second optical element and the initial phase the first optical element is π according to some embodiments of the present disclosure.

FIG. 13 is a schematic diagram showing an example when the difference between the initial phase of the second optical element and the initial phase the first optical element is 3π/2 according to some embodiments of the present disclosure.

FIG. 14A and FIG. 14B are schematic diagrams showing adjusting the initial phase of the third optical element to control the scanning FOV according to some embodiments of the present disclosure.

FIG. 15 is a schematic diagram showing a method for controlling a scanning FOV of the ranging apparatus according to some embodiments of the present disclosure.

### DETAILED DESCRIPTION OF THE EMBODIMENTS

To describe the present disclosure clearly, the technical solutions in embodiments of the present disclosure are described in conjunction with accompanying drawings below. The described embodiments are only some embodiments not all the embodiments of the present disclosure. The present disclosure is not limited by embodiments described here. Based on the embodiments of the disclosure, all other embodiments obtained by those of ordinary skill in the art without any creative work are within the scope of the present disclosure.

A ranging apparatus and a control method for a scanning field of view (FOV) of the ranging apparatus provided by embodiments of the present disclosure may be applied to the ranging apparatus. The ranging apparatus may be an electronic device, such as a LIDAR, or a laser ranging device, etc. In some embodiments, the ranging apparatus may be configured to sense external environmental information, for example, distance information, position information, reflection intensity information, or speed information, etc., of an environmental target. In some embodiments, the ranging apparatus may be configured to detect the distance from a detection object to the ranging apparatus by measuring the light transmission time, i.e., the time-of-flight (TOF), between the ranging apparatus and the detection object. The ranging apparatus may also be configured to detect the distance between the detection object and the ranging apparatus by using other technologies, such as a ranging method based on phase shift measurement or a ranging method based on frequency shift measurement, which is not limited here.

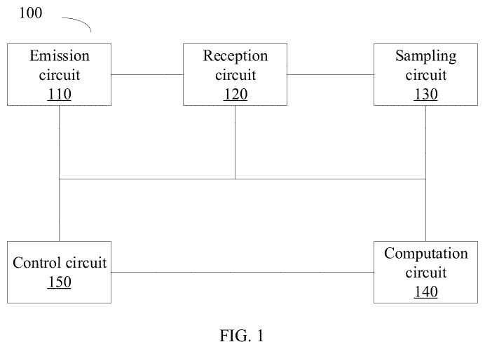

Working processes of distance measurement will be described as an implementation in conjunction with a ranging apparatus 100 shown in FIG. 1. As shown in FIG. 1, the ranging apparatus 100 includes an emission circuit 110, a reception circuit 120, a sampling circuit 130, and a computation circuit 140.

The emission circuit 110 may be configured to emit a light pulse sequence (e.g., a laser pulse sequence). The reception circuit 120 may receive the light pulse sequence reflected by the detection object, perform photoelectric conversion on the light pulse sequence to obtain an electrical signal, and output the processed electrical signal to the sampling circuit 130. The sampling circuit 130 may be configured to perform sampling on the electrical signal to obtain a sampling result. The computation circuit 140 may be configured to determine the distance between the ranging apparatus 100 and the detection object based on the sampling result of the sampling circuit 130.

In some embodiments, the ranging apparatus 100 further includes a control circuit 150. The control circuit 150 may be configured to control other circuits. For example, the control circuit may be configured to control an operation time of each circuit and/or perform parameter settings on each circuit.

As shown in FIG. 1, the ranging apparatus provided by some embodiments includes an emission circuit, a reception circuit, a sampling circuit, and a computation circuit, which are configured to emit and detect a beam. However, the embodiments of the present disclosure are not limited to this. The number of the emission circuit, the reception circuit, the sampling circuit, or the computation circuit may be at least two, which are configured to emit at least two light beams along a same direction or in a different direction. In some embodiments, the at least two light beams may be emitted simultaneously or at different times. In some embodiments, light-emitting dies of the at least two emission circuits may be packaged in a same module. For example, each emission circuit may include one laser emitting die, and laser emitting dies of the at least two emission circuits may be packaged together and accommodated in a same package.

In some implementation manners, in addition to the devices shown in FIG. 1, the ranging apparatus 100 may further include a scanner 160. The scanner 160 may be configured to change a transmission direction of at least one laser pulse sequence emitted by the emission circuit.

A module that includes the emission circuit 110, the reception circuit 120, the sampling circuit 130, and the computation circuit 140, or a module that includes the ranging emission circuit 110, the reception circuit 120, the sampling circuit 130, the computation circuit 140, and the control circuit 150 may be referred to as a ranging device. The ranging device may be independent of other modules, for example, the scanner 160.

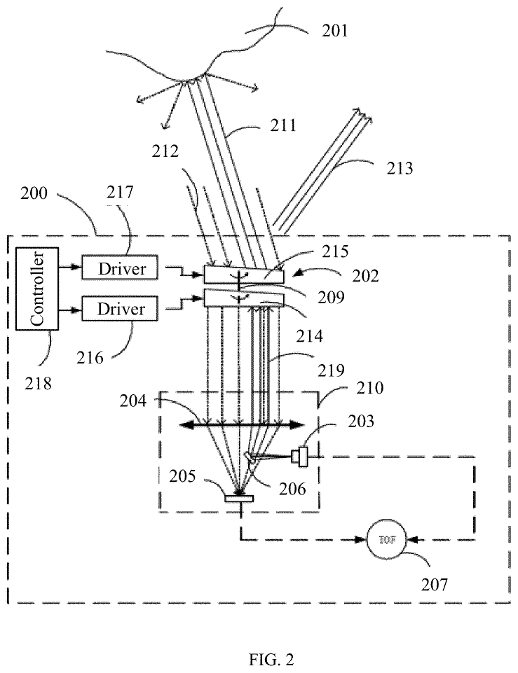

The ranging apparatus may use a co-axial optical path, that is, the light beam emitted from the ranging apparatus and a light beam reflected may share at least a part of the optical path in the ranging apparatus. For example, at least one beam of the light pulse sequence emitted by the emission circuit may be emitted after the transmission direction of at least one beam of the light pulse sequence is changed by the scanner. The laser pulse sequence reflected by the detection object may enter into the reception circuit through the scanner. In some embodiments, the ranging apparatus may use an off-axis optical path, that is, the light beam emitted by the ranging apparatus and the reflected light beam is transmitted at different optical paths in the ranging apparatus. FIG. 2 shows a schematic diagram of the ranging apparatus 100 using the co-axial optical path according to some embodiments of the present disclosure.

A ranging apparatus 200 includes the ranging device 210, and the ranging device 210 includes an emitter 203 (which can include the above-described emission circuit), a collimation element 204, a detector 205 (which can include the above-described reception circuit, sampling circuit, and computation circuit), and an optical path change element 206. The ranging device 210 is configured to emit the light beam, receive a returned light beam, and convert the returned light beam into an electrical signal. In some embodiments, the emitter 203 may be configured to emit the light pulse sequence. In some embodiments, the laser beam emitted by the emitter 203 is a narrow-bandwidth beam with a wavelength outside a visible light range. The collimation element 204 may be arranged on an emission path of the emitter 203. The collimation element 204 may be configured to collimate the light beam emitted from the emitter 203 into parallel light and emit to the scanner. The collimation element 204 may be further configured to converge at least a part of the returned light reflected by the detection object. The collimation element 204 may include a collimation lens or another element that can collimate the light beam.

As shown in FIG. 2, the optical path change element 206 is configured to combine an emission optical path and a reception optical path of the ranging apparatus before the collimation element 204. Thus, the emission optical path and the reception optical path may share the same collimation element to cause the optical path to be more compact. In some other embodiments, each of the emitter 203 and the detector 205 corresponds to a collimation element, and the optical path change element 206 may be arranged at the optical paths after the collimation elements.

As shown in FIG. 2, since a beam aperture of the light beam emitted by the emitter 203 is small, and the beam aperture of the returned light received by the ranging apparatus is relatively large, the optical path change element may use a small-area reflector to combine the emission optical path and the reception optical path. In some implementation manners, the optical path change element may also include a reflector mirror with a through-hole. The through-hole may be configured to allow the emitted light beam of the emitter 203 to pass through. The reflector mirror may be configured to reflect the return beam to the detector 205. As such, blocking of the return beam by the holder of the small reflection mirror that occurs in the case using the small reflection mirror can be reduced.

As shown in FIG. 2, the optical path change element 206 may be off the optical axis of the collimation element 204. In some other embodiments, the optical path change element 206 may be located on the optical axis of the collimation element 204.

The ranging apparatus 200 further includes a scanner 202. The scanner 202 is arranged at the emission optical path of the ranging device 210. The scanner 202 may be configured to change a transmission direction of a collimated beam 219 emitted through the collimation element 204 and project to an external environment, and project the return beam to the collimation element 204. The return beam may be converged at the detector 205 through the collimation element 204.

In some embodiments, the scanner 202 may include at least one optical element. The optical element may be configured to change the transmission path of the light beam. The optical element may be configured to change the transmission path of the light beam by performing reflection, refraction, and diffraction on the light beam, etc., to form a certain scanning FOV. For example, the scanner 202 may include a lens, a mirror, a prism, a galvanometer, a grating, a liquid crystal, an optical phased array, or any combination of the above optical elements.

The ranging apparatus provided by the embodiments of the disclosure includes an emission circuit. The emission circuit may be configured to emit a light pulse signal. The ranging apparatus also includes at least three optical elements. The at least three optical elements are configured to change the transmission direction of the light pulse sequence.

The ranging apparatus further includes a control circuit. The control circuit is configured to control rotation speeds of the at least three optical elements to control at least one of a scan pattern, a position, or a scan density of the scanning FOV, and/or configured to control an extension direction of the scanning FOV by controlling the initial phases of a plurality of optical elements.

In some embodiments, the scanner may include the at least three optical elements. The structure of the scanner is described below. The scanner described below is not limited to being used in the above-described ranging apparatus. The scanner may also be used in a ranging apparatus with other structures or devices for other purposes, which is not limited here.

In some embodiments, at least part of the optical elements may be movable, for example, the at least part of the optical elements may be driven to move by a drive device. The movable optical element may reflect, refract, or diffract the light beam to different directions at different times. In some embodiments, a plurality of optical elements of the scanner 202 may rotate or vibrate around a common axis 209. Each rotating or vibrating optical element may be configured to continuously change a transmission direction of an incident light beam.

In some embodiments, the at least three optical elements of the scanner may rotate around the same rotation axis. Each rotating optical element is configured to continuously change the transmission direction of the light pulse sequence. in some embodiments, each the at least three optical elements may rotate parallel to their respective axes, or the angle between the rotation axes of any two adjacent optical elements of the at least three optical elements is less than 10°. As such, a more comprehensive scanning FOV may be realized through the selective combination of the rotation axes of the at least three optical elements.

In some embodiments, a sum of phase angles of any two adjacent optical elements is around a fixed value, and the variation range does not exceed 20°. The phase angle refers to the angle between the zero position of a light refraction element and a reference direction. In some embodiments, the zero position of the light refraction element refers to a position on the periphery of the light refraction element on a plane perpendicular to the exit optical path of the light pulse sequence. The reference direction refers to a radial direction of the light refraction element on a plane perpendicular to the exit optical path of the light pulse sequence.

In some embodiments, during the rotation of the at least three optical elements, the sum of the phase angles of any two adjacent optical elements is the fixed value.

In some embodiments, the at least three optical elements include three light refraction elements arranged side by side along the exit optical path of the light pulse sequence. The light refraction element includes a light exit surface and a light entrance surface, which are non-parallel to each other.

In some embodiments, a plurality of optical elements of the scanner 202 may rotate at different rotation speeds or vibrate at different speeds. In some embodiments, at least part of the optical elements of the scanner 202 may rotate at an approximately same rotation speed. In some embodiments, a plurality of optical elements of the scanner may also rotate around different axes. In some embodiments, the plurality of optical elements of the scanner may also rotate around the same direction or the different direction, or vibrate in the same direction or vibrate in different directions, which is not limited here.

In some embodiment, the scanner 202 includes a first optical element 214 and a first driver 216 connected to the first optical element 214. The first driver 216 may be configured to drive the first optical element 214 to rotate around the rotation axis 209 to cause the first optical element 214 to change the direction of a collimated beam 219. The first optical element 214 projects the collimated beam 219 to different directions. In some embodiments, an included angle between the rotation axis 209 and the direction of the collimated beam 219 after being changed by the first optical element may change as the first optical element 214 rotates. In some embodiments, the first optical element 214 may include a pair of opposite non-parallel surfaces. The collimated light beam 219 passes the pair of surfaces. In some embodiments, the first optical element 214 includes a prism. The thickness of the prism changes along at least one radial direction. In some embodiments, the first optical element 214 may include a wedge angle prism. The wedge angle prism may be configured to refract the collimated beam 219.

In some embodiments, the scanner 202 further includes a second optical element 215. The second optical element 215 rotates around the rotation axis 209. The second optical element 215 and the first optical element 214 may have different rotation speeds. The second optical element 215 may be configured to change the direction of the light beam projected by the first optical element 214. In some embodiments, the second optical element 215 are connected to a second driver 217. The second driver 217 may be configured to drive the second optical element 215 to rotate. The first optical element 214 and the second optical element 215 may be driven by the same or different drivers, such that the rotation speeds and/or rotation directions of the first optical element 214 and the second optical element 215 are different. Thus, the collimated beam 219 may be projected to different directions of external space to scan a relatively large space area. In some embodiments, a controller 218 may be configured to control the drivers 216 and 217 to drive the first optical element 214 and the second optical element 215, respectively. The rotation speeds of the first optical element 214 and the second optical element 215 may be determined according to an expected scan area and style in practical applications. The drivers 216 and 217 may include motors or other drivers.

In some embodiments, the second optical element 215 may include a pair of opposite surfaces that are not parallel. The beam may pass through the pair of surfaces. In some embodiments, the second optical element 215 may include at least a lens whose thickness changes along a radial direction. In some embodiments, the second optical element 215 may include a wedge angle prism.

In some embodiments, the scanner 202 further includes a third optical element (not shown) and a third driver for driving the third optical element to move. In some embodiments, the third optical element may include a pair of opposite non-parallel surfaces. The light beam may pass through the pair of surfaces. In some embodiments, the third optical element may include the prism. The thickness of the prism changes along a radial direction. In some embodiments, the third optical element may include a wedge angle prism. At least two of the first optical element, the second optical element, or the third optical element may rotate at different rotation speeds and/or in different directions.

In some embodiments, the control circuit controls the rotation speeds of the three optical elements to control the scanning FOV, which includes the followings.

The rotation speed of the first optical element is a first rotation speed.

The rotation speed of the second optical element is a second rotation speed, and the second rotation speed is the sum of a first proportion of a first integer power of the first rotation speed and a first constant.

The rotation speed of the third optical element is a third rotation speed, and the third rotation speed is the sum of a second proportion of a second integer power of the first rotation speed and a second constant.

The first optical element rotates at the first rotation speed, the second optical element rotates at the second rotation speed, and the third optical element rotates at the third rotation speed to obtain the scanning FOV.

In some embodiments, when the rotation speeds (unit: rpm) of the three optical elements adopt the following combination relationship, different scanning FOVs may be obtained by scanning. The difference of the scanning FOVs can differ from each other in at least one of the scan pattern, the position, or the scan density of the scanning FOV. The rotation speed relationship of the three optical elements is as follows.

The rotation speed of the first optical element is w1. w1 is an integer.

The rotation speed of the second optical element is represented as:

w2=k1×w1ⁿ¹+dw1

where k1, w1, n1, and dw1 are all integers.

The rotation speed of the third optical element is represented as:

w3=k2×w1ⁿ²+dw2

where k2, w2, n2, and dw2 are all integers.

The rotation speed of the second optical element has a linear relationship with the exponential power of the rotation speed of the first optical element. Similarly, the rotation speed of the third optical element has a linear relationship with the exponential power of the rotation speed of the first optical element. As such, different scanning FOVs can be obtained by setting different k1, w1, n1, dw1, and k2, w2, n2, dw2.

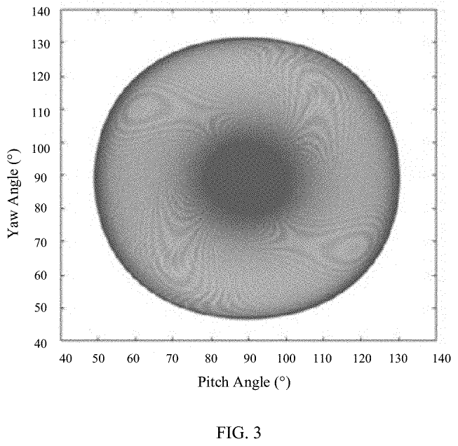

In some embodiments, FIG. 3 shows a first scanning FOV according to some embodiments of the present disclosure. The first scanning FOV is circular or approximately circular, which is a maximum FOV that can result from the rotation of three prisms. A maximum diameter of the circle is determined according to the wedge angles and refractive indices of the three prisms.

In some embodiments, the control circuit controls two adjacent first optical elements and second optical elements of the three optical elements to rotate oppositely, with the difference between the rotation speeds of the two adjacent optical elements being less than a first value, so as to obtain a second scanning FOV.

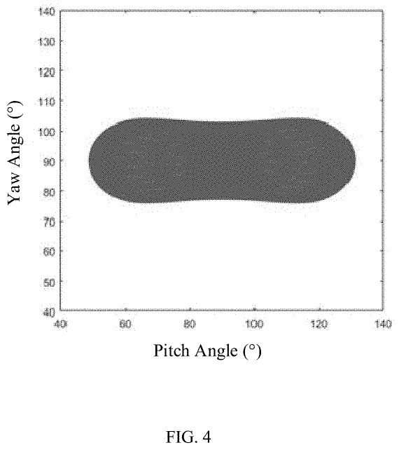

In some embodiments, the control circuit controls the rotation speeds of two adjacent first optical elements and second optical elements of the at least three optical elements to be equal, and the rotation speed of the third optical element of the three optical elements to be different from the rotation speed of the first optical element, so as to obtain a third scanning FOV. In some embodiments, the first rotation speed, the first proportion, the first constant, and the third speed may be set as k1=−1, dw1=0, w1≠0, and w3≠0, that is, the first optical element and the second optical element are controlled to rotate in opposite directions at a same rotation speed, While the rotation speed of the third optical element is not controlled, so as to obtain a third scanning FOV as shown in FIG. 4. FIG. 4 shows the third scanning FOV according to some embodiments of the present disclosure. For example, when the optical scanning system is applied to an automotive radar, since targets at a horizontal direction are many, a large coverage FOV is needed, while a vertical direction has low requirements for the FOV. Therefore, the scanning method of the ranging apparatus of the present disclosure may realize an FOV that meets the requirements.

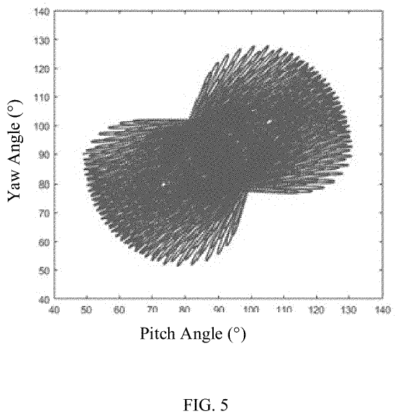

In some embodiments, the control circuit controls the rotation speed of the second optical element to be the sum of −1 times the integer power of the rotation speed of the first optical element and the first constant, where the first constant is an integer with an absolute value less than 60, and controls the rotation speed of the third optical element to be a non-zero integer, that is, k1=−1, 0<|dw1|<60, w3≠0, so as to obtain a fourth scanning FOV as shown in FIG. 5. FIG. 5 shows the fourth scanning FOV according to some embodiments of the present disclosure.

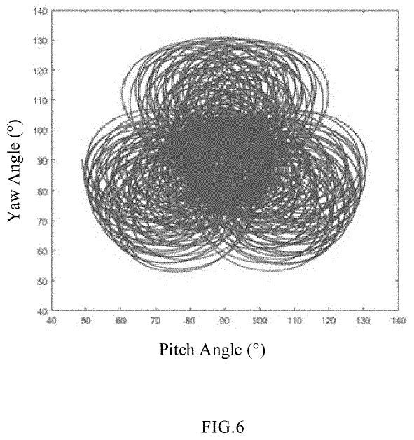

In some embodiments, the control circuit controls the rotation speed of the second optical element to be the sum of −2 times the integer power of the rotation speed of the first optical element and the first constant, where the first constant is an integer with an absolute value less than 60, and controls the rotation speed of the third optical element to be a non-zero integer, that is, k1=−2, |dw1|<60, w3≠0, so as to obtain a fifth scanning FOV as shown in FIG. 6. FIG. 6 shows the fifth scanning FOV according to some embodiment of the present disclosure.

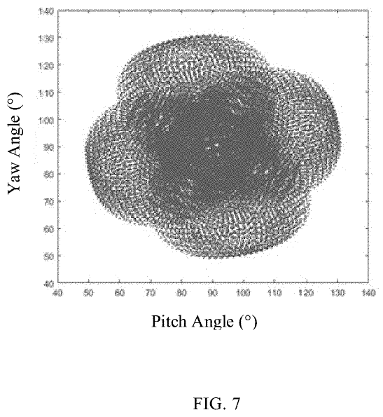

In some embodiments, the control circuit controls the rotation speed of the second optical element to be the sum of −3 times the integer power of the rotation speed of the first optical element and the first constant, where the first constant is an integer with the absolute value less than 60, and controls the rotation speed of the third optical element to be a non-zero integer, that is, k1=−3, |dw1|<60, w3≠0, so as to obtain a sixth scanning FOV as shown in FIG. 7. FIG. 7 shows the sixth scanning FOV according to some embodiment of the present disclosure.

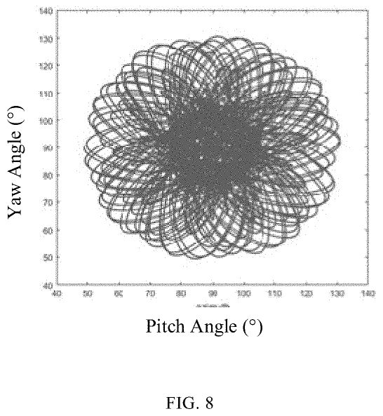

In some embodiments, the control circuit controls the rotation speed of the second optical element to be the sum of −1 times the integer power of the rotation speed of the first optical element and the first constant, where the first constant is an integer with the absolute value more than or equal to 60 and less than the absolute value of the rotation speed of the first optical element, and controls the rotation speed of the third optical element to be a non-zero integer, that is, k1=−1, 60≤|dw1|<|w1|, w3≠0, so as to obtain the seventh scanning FOV as shown in FIG. 8. FIG. 8 shows an implementation of the seventh scanning FOV according to some embodiment of the present disclosure.

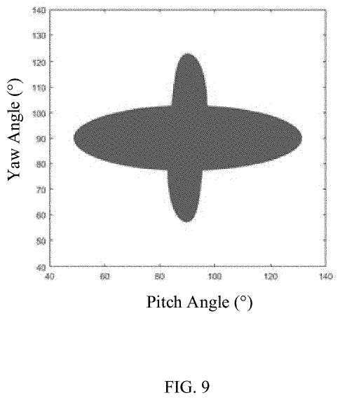

In an embodiment, the control circuit controls the rotation speed of the second optical element to be the sum of an integer multiple of the rotation speed of the first optical element and the first constant, where the rotation speed of the third optical element is the sum of the integral multiple of the integral power of the rotation speed of the first optical element and the second constant. The first constant and the second constant are opposite to each other, that is, dw1=−dw2, so as to obtain an eighth scanning FOV as shown in FIG. 9. FIG. 9 shows the eighth scanning FOV according to some embodiment of the present disclosure.

In some embodiments, the control circuit controls the scanning FOV by controlling the initial phases of the plurality of optical elements, which includes the following.

The rotation speeds of the first optical element, the second optical element, and the third optical element remain fixed.

The difference between the initial phase of the second optical element and the initial phase of the first optical element is controlled to change in a range of [0, 2π], and the scanning FOV rotates 360° about a center of the scanning FOV.

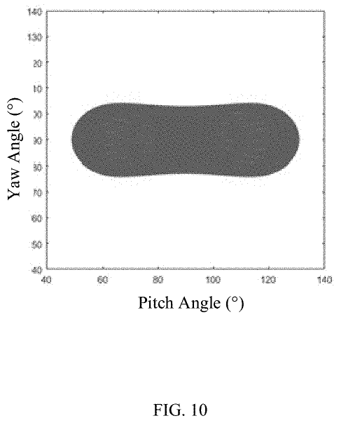

In some embodiments, when the rotation speed combination of the three prisms is fixed, taking the rotation speed combination w1, w2 =−w1, w3 as an example, when the rotation angle restrains of various prisms are different, the position of the scanning FOV can be controlled. As shown in FIG. 10 to FIG. 13, where the phase relationship satisfies p1=b1, p2=p1+b2, p3 =b3, and b1∈[0, 2π], b2∈[0, 2π], b3∈[0, 2π] (p1, p2, and p3 represent the initial phases of the first optical element, the second optical element, and the third optical element, respectively, and b2 represents the difference between the initial phases of the first optical element and the second optical element), with different b1 and b2 values, the extension direction of the scanning FOV can be controlled, and the value of b3 does not affect the FOV control under this rotation speed relationship.

In some embodiments, when b1=0, b2=0, the initial phase difference between the second optical element and the first optical element is 0, the resulting scanning FOV is shown in FIG. 10.

In some embodiments, when the rotation speed combination of the three prisms is fixed, taking the rotation speed combination w1, w2=−w1, w3 as an example, when the rotation angle restrains of various prisms are different, the position of the scanning FOV can be controlled. As shown from FIG. 10 to FIG. 13, where the phase relationship satisfies is p1=b1, p2=p1+b2, p3+b3, and b1∈[0, 2π], b2∈[0, 2π], b3∈[0, 2π] with b1 and b2 are different values, the extension direction of the scanning FOV can be controlled, and the value of b3 does not affect the FOV control under this rotation speed the relationship.

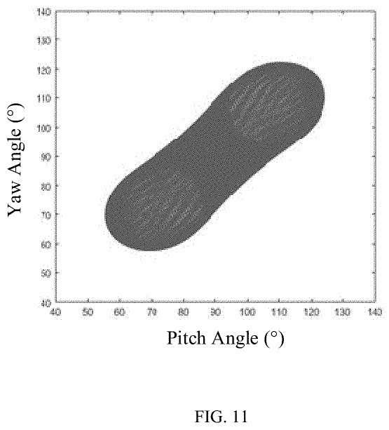

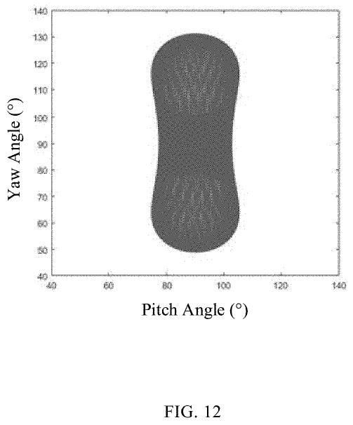

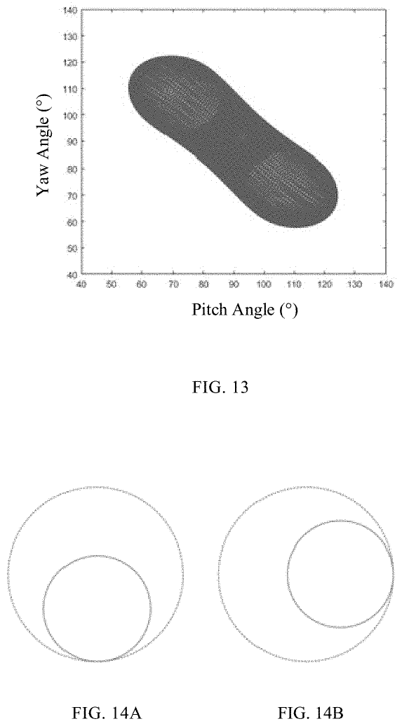

For example, when b1=0, b2=0, the initial phase difference between the second optical element and the first optical element is 0, the resulting scanning FOV is shown in FIG. 10. When b1=0, b2=π/2, the initial phase difference between the second optical element and the first optical element is π/2, the resulting scanning FOV is shown in FIG. 11. When b1=0, b2=π, the initial phase difference between the second optical element and the first optical element is π, the resulting scanning FOV is shown in FIG. 12. When b1=0, b2=3π/2, the initial phase difference between the second optical element and the first optical element is 3π/2, the resulting scanning FOV is shown in FIG. 13. As such, when the combination of rotation speeds of the first optical element, the second optical element, and the third optical element is maintained, controlling initial phase of the second optical element and the initial phase of the first optical element is controlled to change by π/2 each time can result in the scanning FOV rotating 360° with the center as a reference. with each time rotating by π/4.

In some embodiments, the control circuit controlling the scanning field of view by controlling the initial phases of the plurality of optical elements includes the following.

The first optical element and the second optical element may be kept rotating at any speed and direction. The initial phase of the third optical element is adjusted to change the position of a small scanning FOV formed by the first optical element and the second optical element in a large scanning field of view formed by the first optical element, the second optical element, and the third optical element.

FIG. 14A and FIG. 14B show an example of adjusting an initial phase of the third optical element to control the scanning FOV according to some embodiments of the present disclosure. As shown in FIG. 14A, an intersection of the small scanning FOV and the large scanning FOV is at the bottom. After the initial phase of the third optical element is adjusted, as shown in FIG. 14B, the intersection of the small scanning FOV and the large scanning FOV rotates 90° counterclockwise.

As shown in FIG. 2, the rotation of each optical element of the scanner 202 can project light to different directions, such as the directions of the lights 211 and 213, so as to scan the space around the ranging apparatus 200. When the light 211 projected by the scanner 202 hits a detection object 201, a part of the light is reflected by the detection object 201 to the ranging apparatus 200 in the direction opposite to the projected light 211. The returned light 212 reflected by the detection object 201 is incident on the collimation element 204 after passing through the scanner 202.

The detector 205 and the emitter 203 are arranged at a same side of the collimation element 204, and the detector 205 is configured to convert at least part of the returned light passing through the collimation element 204 to electrical signals.

In some embodiments, an anti-reflection film may be coated on each optical element. In some embodiments, the thickness of the anti-reflection film may be equal to or close to a wavelength of the light beam emitted by the emitter 203. The anti-reflection film may increase the intensity of the transmitted beam.

In some embodiments, a light filter layer may be coated on a surface of an element of the ranging apparatus in the transmission path of the beam, or a light filter device may be arranged at the beam transmission path, which may be configured to transmit the light with a wavelength within the wavelength band of the beam emitted by the emitter and reflect the light of another wavelength band. Thus, the noise caused by environmental light may be reduced for the receiver.

In some embodiments, the emitter 203 may include a laser diode. The laser diode may be configured to emit nano-second laser pulses. Further, a laser pulse reception time may be determined by the nano-second laser pulse. For example, reception time of the laser pulse may be determined by detecting an ascending edge time and/or a descending edge time of the electrical signal pulse. As such, the ranging apparatus 200 may be configured to calculate the TOF by using the pulse reception time information and the pulse transmission time information to determine the distance between the detection object 201 and the ranging apparatus 200.

The distance and orientation detected by the ranging apparatus 200 may be used for remote sensing, obstacle avoidance, surveying and mapping, modeling, navigation, etc. In some embodiments, the ranging apparatus of embodiments of the present disclosure may be applied to a mobile platform. The ranging apparatus may be mounted at a platform body of the mobile platform. The mobile platform having the ranging apparatus may perform measurement on the external environment. For example, a distance between the mobile platform and an obstacle may be measured to avoid the obstacle, and 2-dimensional and 3-dimensional surveying and mapping may be performed on the external environment. In some embodiments, the mobile platform may include at least one of an unmanned aerial vehicle (UAV), a vehicle (including a car), a remote vehicle, a ship, a robot, or a camera. When the ranging apparatus is applied to the UAV, the platform body may be a vehicle body of the UAV. When the ranging apparatus is applied to the car, the platform body may be a body of the car. The car may include an auto-pilot car or a semi-auto-pilot car, which is not limited here. When the ranging apparatus is applied to the remote vehicle, the platform body may be the vehicle body of the remote vehicle. When the ranging apparatus is applied to the robot, the platform body may be the robot. When the ranging apparatus is applied to the camera, the platform body may be a camera body.

A rotary LIDAR operates by rotating a single laser beam 360° around an axis, such that the laser beam scan a plane. A mechanical rotary LIDAR includes a plurality of rotatable prisms. Different wedge angles, refractive indices, rotation speeds, and/or relative phases of the prisms can result in the change of the shape and position of the scanning FOV. Thus, the scanning FOV of the ranging apparatus may be controlled by controlling the relevant parameters of the prisms.

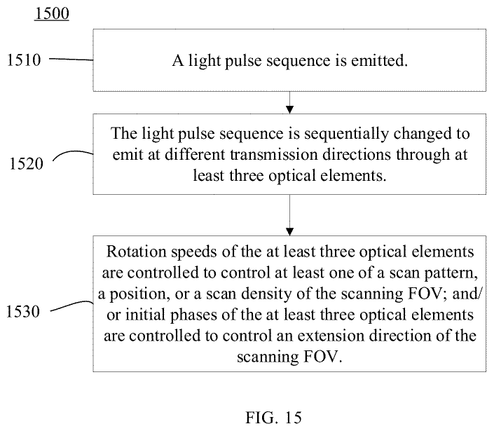

Embodiments of the present disclosure provide a method for controlling the scanning FOV of a ranging apparatus. FIG. 15 shows a control method 1500 for controlling the scanning FOV of a ranging apparatus according to some embodiments of the present disclosure. The control method 1500 includes the followings.

At 1510, a light pulse sequence is emitted.

At 1520, the light pulse sequence is sequentially changed to emit at different transmission directions through at least three optical elements.

At 1530, rotation speeds of the at least three optical elements are controlled to control at least one of a scan pattern, a position, or a scan density of the scanning FOV; and/or initial phases of the at least three optical elements are controlled to control an extension direction of the scanning FOV.

The at least three optical elements are configured to change the transmission direction of the light pulse sequence, then the scanning FOV of the ranging apparatus is related to the parameters of the optical elements, such as the wedge angles, the refractive indices, the rotation speeds, or relative phases.

In some embodiments, the mechanical rotating lidar includes three rotatable prisms. Different wedge angles, refractive indices, rotation speeds, and/or relative phases of the prisms can result in the change of the shape and position of the scanning FOV. Thus, the scanning FOV of the ranging apparatus may be controlled by controlling the relevant parameters of the prisms. In some embodiments, the at least three optical elements include three light refraction elements arranged side by side along the exit optical path of the light pulse sequence. The light refraction element includes a light exit surface and a light entrance surface, which are non-parallel to each other.

The at least three optical elements may be a lens, a mirror, a prism, a grating, an optical phased array, or any combination of the foregoing optical elements.

In some embodiments, the at least three optical elements of the scanner may rotate around the same rotation axis. Each rotating optical element is configured to continuously change the transmission direction of the light pulse sequence. in some embodiments, each the at least three optical elements may rotate parallel to their respective axes, or the angle between the rotation axes of any two adjacent optical elements of the at least three optical elements is less than 10°.

In some embodiments, a sum of phase angles of any two adjacent optical elements is around a fixed value, and the variation range does not exceed 20°. The phase angle refers to the angle between the zero position of a light refraction element and a reference direction. In some embodiments, the zero position of the light refraction element refers to a position on the periphery of the light refraction element on a plane perpendicular to the exit optical path of the light pulse sequence. The reference direction refers to a radial direction of the light refraction element on a plane perpendicular to the exit optical path of the light pulse sequence.

In some embodiments, during the rotation of the at least three optical elements, the sum of the phase angles of any two adjacent optical elements is the fixed value.

In some embodiments, the at least three optical elements include three wedge prisms.

In some embodiments, the rotation speeds of the at least three optical elements are controlled to control the scanning FOV. The controlling of the rotating speeds includes the followings.

The rotation speed of the first optical element is the first rotation speed.

The rotation speed of the second optical element is the second rotation speed, and the second rotation speed is the sum of the first proportion of the first integer power of the first rotation speed and the first constant.

The rotation speed of the third optical element is the third rotation speed, and the third rotation speed is the sum of the second proportion of the second integer power of the first rotation speed and the second constant.

The first optical element rotates at the first rotation speed, the second optical element rotates at the second rotation speed, and the third optical element rotates at the third rotation speed to obtain the scanning FOV.

For example, assume that for prism 1, the wedge angle is a1, the refractive index is z1, the initial phase is p1, and the rotation speed is w1; for prism 2, the wedge angle is a2, the refractive index is z2, the initial phase is p2, and the rotation speed is w2; and for prism 3, the wedge angle is a3, the refractive index is z3, the initial phase is p3, and the rotation speed is w3. FIG. 3 shows the first scanning FOV according to some embodiments of the present disclosure. The first scanning FOV is circular or approximately circular, which is the maximum FOV that can result from three prisms. The maximum diameter of the circle is determined by the wedge angles and the refractive indices of the three prisms. In some embodiments, when the rotation speeds (unit: rpm) of the three prisms adopt the following combination relationship, different scanning FOV may be obtained by scanning. The difference of the scanning FOVs can differ from each other at least one of the scan pattern, the position, or the scan density.

The rotation speed relationship of the three optical elements is as follows.

The rotation speed of prism 1 is w1, and w1 is an integer.

The rotation speed of the prism 2 is represented as:

w2=k1×w1ⁿ¹+dw1

where k1, w1, n1, and dw1 are all integers.

The rotation speed of the third optical element is represented as:

w3=k2×w1ⁿ²+dw2

where k2, w2, n2, and dw2 are all integers.

The rotation speed of the prism 2 has a linear relationship with the exponential power of the rotation speed of the prism 1. The rotation speed of the prism 3 has a linear relationship with the exponential power of the rotation speed of the prism 1. Different scanning FOVs can be obtained by setting different k1, w1, n1, dw1 and k2, w2, n2, dw2.

In some embodiments, the control circuit controls two adjacent first optical elements and second optical elements of the three optical elements to rotate oppositely, with the difference between the rotation speeds of the two adjacent optical elements being controlled less than the first value, so as to obtain the second scanning FOV.

In some embodiments, the control circuit controls the rotation speeds of two adjacent first optical elements and second optical elements of the at least three optical elements to be equal, and the rotation speed of the third optical element of the three optical elements to be different from the rotation speed of the first optical element, that is, k1=−1, dw1=0, w1≠0, w3≠0, that is, the rotation direction of the second optical element is controlled to be opposite to the rotate direction of the first optical element, and the rotation speed of the two optical elements are controlled to be the same. The rotation speed of the third optical element is not controlled, so as to obtain the third scanning FOV as shown in FIG. 4.

As shown in FIG. 4, for example, when the optical scanning system is applied to an automotive radar, since targets at a horizontal direction are many, a large coverage FOV is needed, while a vertical direction has low requirements for the FOV. Therefore, the scanning method of the ranging apparatus of the present disclosure may realize an FOV that meets the requirements.

In some embodiments, the control circuit controls the rotation speed of the second optical element to be the sum of −1 times the integer power of the rotation speed of the first optical element and the first constant, where the first constant is an integer with an absolute value less than 60, and controls the rotation speed of the third optical element to be a non-zero integer, that is, k1=−1, 0<|dw1|<60, w3≠0, so as to obtain the fourth scanning FOV as shown in FIG. 5. FIG. 5 shows a fourth scanning FOV according to some embodiments of the present disclosure.

In some embodiments, the control circuit controls the rotation speed of the second optical element to be the sum of −2 times the integer power of the rotation speed of the first optical element and the first constant, where the first constant is an integer with the absolute value less than 60, and control the rotation speed of the third optical element to be a non-zero integer, that is, k1=−2, |dw1|<60, w3≠0, so as to obtain the fifth scanning FOV shown in FIG. 6. FIG. 6 shows the fifth scanning FOV according to some embodiment of the present disclosure.

In some embodiments, the control circuit controls the rotation speed of the second optical element to be the sum of −3 times the integer power of the rotation speed of the first optical element and the first constant, where the first constant is an integer with the absolute value less than 60, and controls the rotation speed of the third optical element to be a non-zero integer, that is, k1=−3, |dw1|<60, w3≠0, so as to obtain the sixth scanning FOV shown in FIG. 7. FIG. 7 shows the sixth scanning FOV according to some embodiment of the present disclosure.

In some embodiments, the control circuit controls the rotation speed of the second optical element to be the sum of −1 times the integer power of the rotation speed of the first optical element and the first constant, where the first constant is an integer with the absolute value more than or equal to 60 and less than the absolute value of the rotation speed of the first optical element, and controls the rotation speed of the third optical element to be a non-zero integer, that is, k1=−1, 60≤|dw1|<|w1|, w3≠0, so as to obtain the seventh scanning FOV shown in FIG. 8. FIG. 8 shows the seventh scanning FOV according to some embodiment of the present disclosure.

In some embodiments, the control circuit controls the rotation speed of the second optical element to be the sum of an integer multiple of the rotation speed of the first optical element and the first constant. The rotation speed of the third optical element is the sum of the integral multiple of the integral power of the rotation speed of the first optical element and a second constant, where the first constant and a second constant opposite to each other, that is, dw1=−dw2, so as to obtain the eighth scanning FOV shown in FIG. 9. FIG. 9 shows the eighth scanning FOV according to some embodiment of the present disclosure.

In this disclosure, the rotation speed of an optical element is described as a non-zero integer. This is because, in this disclosure, the rotation speed is measured using the unit of rpm (round per minutes) as an example. In general, the rotation speed of an optical element can be considered to be just non-zero.

In some embodiments, the control circuit controlling the scanning FOV by controlling the initial phases of the plurality of optical elements includes the followings.

The rotation speeds of the first optical element, the second optical element, and the third optical element are kept fixed.

The difference between the initial phase of the second optical element and the initial phase of the first optical element is controlled to change in a range of [0, 2π], and the scanning FOV rotates 360° about a center of the scanning FOV.

In some embodiments, when the rotation speed combination of the three prisms is fixed, taking the rotation speed combination w1, w2=−w1, w3 as an example, when the rotation angle restrains of various prisms are different, the position of the scanning FOV can be controlled. As shown from FIG. 10 to FIG. 13, where the phase relationship satisfies is p1=b1, p2=p1+b2, p3+b3, and b1∈[0, 2π], b2∈[0, 2π], b3∈[0, 2π] with b1 and b2 are different values, the extension direction of the scanning FOV can be controlled, and the value of b3 does not affect the FOV control under this rotation speed the relationship.

For example, when b1=0, b2=0, the initial phase difference between the second optical element and the first optical element is 0, the resulting scanning FOV is shown in FIG. 10. When b1=0, b2=π/2, the initial phase difference between the second optical element and the first optical element is π/2, the resulting scanning FOV is shown in FIG. 11. When b1=0, b2=a, the initial phase difference between the second optical element and the first optical element is π, the resulting scanning FOV is shown in FIG. 12. When b1=0, b2=3π/2, the initial phase difference between the second optical element and the first optical element is 3π/2, the resulting scanning FOV is shown in FIG. 13. As such, when the combination of rotation speeds of the first optical element, the second optical element, and the third optical element is maintained, controlling initial phase of the second optical element and the initial phase of the first optical element is controlled to change by π/2 each time can result in the scanning FOV rotating 360° with the center as a reference, with each time rotating by π/4.

[symbol]

In some embodiments, the control method controlling the scanning FOV by controlling the initial phases of the plurality of optical elements includes the followings.

The first optical element and the second optical element may rotate at any speed and direction. The initial phase of the third optical element is adjusted to change the position of the small scanning FOV formed by the first optical element and the second optical element. The position refers to the position of the small scanning FOV in the large scanning field of view formed by the first optical element, the second optical element, and the third optical element.

As shown in FIG. 14A and FIG. 14B, FIG. 14A and FIG. 14B shows that the initial phase of the third optical element is adjusted to control the scanning FOV according to some embodiments of the present disclosure. As shown in FIG. 14A, the intersection of the small scanning FOV and the large scanning FOV is at the bottom. After adjusting the initial phase of the third optical element, as shown in FIG. 14B, the intersection of the small scanning FOV and the large scanning FOV rotates 90° counterclockwise.

In practical applications, the scanning FOV of the LIDAR may be determined according to actual application scenarios and user needs, or the scanning FOV may be dynamically adjusted according to actual conditions. Refraction elements may include different wedge angles and refractive indices for different beams. The beam stretching/compression in a specific direction may be realized by controlling the wedge angle, the relative position, the tilt angle, or material selection of the beam refraction element group, thereby realizing a large light spot and large FOV coverage in the specific direction.

Embodiments of the present disclosure provide the method for controlling the scanning FOV of the ranging apparatus and the ranging apparatus. The rotation speeds and/or initial phases of the plurality of optical elements are controlled to obtain different scanning FOVs, which can cover the scan range with different patterns, so as to meet different application needs and be widely used on various occasions.

Terms used in the present disclosure describe merely specific embodiments but are not intended to limit the present disclosure. The singular forms of “a,” “one,” and “said/the” used in the present disclosure and the appended claims are also intended to include plural forms unless the context indicates other meanings. Use of the terms “including” and/or “containing” in the specification indicates the existence of associated features, integers, steps, operations, elements, and/or components, but does not exclude the existence or addition of one or more other features, integers, steps, operations, elements, and/or components.

Corresponding structures, materials, actions, and equivalents (if any) of all devices or steps and functional elements in the appended claims are intended to include any structure, material, or action for performing the function in combination with other needed elements. The description of the present disclosure is given for the purpose of example and description but is not intended to be exhaustive or to limit the disclosure to the disclosed form. Without departing from the scope and spirit of the present disclosure, various modifications and variations will be apparent to those skilled in the art. The embodiments described in the present disclosure can better reveal the principles and practical applications of the present disclosure, and enable those skilled in the art to understand the present disclosure.

The flow chart described in the present disclosure is exemplary. For those skilled in the art, various changes or improvements can be made to the above-described embodiments. It is apparent that such changes or improvements are within the technical scope of the present disclosure. For example, these steps can be performed in a different order, or some steps can be added, deleted, or modified. Those of ordinary skill in the art can understand and implement all or some of the processes for implementing the above-described embodiments. According to the description of the disclosure, such equivalent changes are still within the scope of the present disclosure.

What is claimed is:

1. A method for controlling a scanning field of view (FOV) of a ranging apparatus comprising:
emitting a light pulse sequence;
changing the light pulse sequence to exit at different directions via at least three optical elements; and
controlling the scanning FOV by controlling the at least three optical elements, including at least one of:
controlling at least one of a scan pattern, a position, or a scanning density of the scanning FOV by controlling rotation speeds of the at least three optical elements; or
controlling an extension direction of the scanning FOV by controlling initial phases of the at least three optical elements.

2. The method according to claim 1, wherein:
the at least three optical elements include three light refraction elements arranged side by side along an emission optical path of the light pulse sequence; and
each of the light refraction elements includes a light exit surface and a light entrance surface that are not parallel to each other.

3. The method according to claim 1, wherein:
the at least three optical elements rotate around a same rotation axis;
rotation axes of the at least three optical elements are parallel to each other; or
an included angle between the rotation axes of any two adjacent optical elements of the at least three optical elements is less than 10°.

4. The method according to claim 1, wherein:
a sum of phase angles of any two adjacent optical elements of the at least three optical elements is around a fixed value with a variation range not exceeding 20°; and
the phase angle of an optical element refers to an angle between a zero position of the optical element and a reference direction.

5. The method according to claim 4, wherein the sum of the phase angles of any two adjacent optical elements is the fixed value during rotation of the at least three optical elements,

6. The method according to claim 1, wherein the at least three optical elements include three wedge angle prisms.

7. The method according to claim 1, wherein controlling the scanning FOV includes:
controlling the scanning FOV to be a circular or an approximately circular scanning FOV by controlling the rotation speeds of the at least three optical elements.

8. The method according to claim 1, wherein controlling the scanning FOV includes:
controlling rotation directions of two adjacent optical elements of the at least three optical elements to be opposite to each other, and a difference between the rotation speeds of the two adjacent optical elements to be less than a value.

9. The method according to claim 1, wherein controlling the scanning FOV includes:
controlling rotation directions of two adjacent optical elements of the at least three optical elements to be opposite to each other, the rotation speeds of the two adjacent optical elements to be equal, and the rotation speed of another optical element of the at least three optical elements to be different from the rotation speeds of the two adjacent optical elements.

10. The method according to claim 1, wherein:
the at least three optical elements include a first optical element, a second optical element, and a third optical element;
the first optical element and the second optical element are adjacent to each other; and
controlling the scanning FOV includes:
controlling the rotation speed of the second optical element to be a sum of −1 times an integer power of the rotation speed of the first optical element and a constant, the constant being an integer with an absolute value less than 60; and
controlling the rotation speed of the third optical element to be non-zero.

11. The method according to claim 6, wherein:
the at least three optical elements include a first optical element, a second optical element, and a third optical element;
the first optical element and the second optical element are adjacent to each other; and
controlling the scanning FOV includes:
controlling the rotation speed of the second optical element to be a sum of −2 times an integer power of the rotation speed of the first optical element and a constant, the constant being an integer with an absolute value less than 60; and
controlling the rotation speed of the third optical element to be non-zero.

12. The method according to claim 1, wherein:
the at least three optical elements include a first optical element, a second optical element, and a third optical element;
the first optical element and the second optical element are adjacent to each other; and
controlling the scanning FOV includes:
controlling the rotation speed of the second optical element to be a sum of −3 times an integer power of the rotation speed of the first optical element and a constant, the constant being an integer with an absolute value less than 60; and
controlling the rotation speed of the third optical element to be non-zero.

13. The method according to claim 1, wherein:
the at least three optical elements include a first optical element, a second optical element, and a third optical element;
the first optical element and the second optical element are adjacent to each other; and
controlling the scanning FOV includes:
controlling the rotation speed of the second optical element to be a sum of −1 times an integer power of the rotation speed of the first optical element and a constant, the constant being an integer with an absolute value larger than or equal to 60 and less than an absolute value of the rotation speed of the first optical element; and
controlling the rotation speed of the third optical element to be non-zero.

14. The method according to claim 1, wherein:
the at least three optical elements include a first optical element, a second optical element, and a third optical element;
the first optical element and the second optical element are adjacent to each other; and
controlling the scanning FOV includes:
controlling the rotation speed of the second optical element to be a sum a first integer multiple of a first integer power of the rotation speed of the first optical element and a first constant; and
controlling the rotation speed of the third optical element to be a sum of a second integer multiple of a second integer power of the rotation speed of the first optical element and a second constant opposite to the first constant.

15. The method according to claim 1, wherein:
the at least three optical elements include a first optical element, a second optical element, and a third optical element;
the first optical element and the second optical element are adjacent to each other; and
controlling the scanning FOV includes:
maintaining the rotation speeds of the first optical element, the second optical element, and the third optical element; and
controlling a difference between the initial phase of the second optical element and the initial phase of the first optical element to change between [0, 2π].

16. The method according to claim 1, wherein:
the at least three optical elements include a first optical element, a second optical element, and a third optical element;
the first optical element and the second optical element are adjacent to each other; and
controlling the scanning FOV includes:
adjusting the initial phase of the third optical element to change a position of a small scanning FOV formed by the first optical element and the second optical element in a large scanning FOV formed by the first optical element, the second optical element, and the third optical element.

17. The method according to claim 1, further comprising:
receiving an optical signal of the light pulse sequence reflected by an object and sequentially passing through the at least three optical elements; and
detecting at least one of distance or position information of the object according to the light pulse sequence and the optical signal.

18. A ranging apparatus comprising:
an emitter configured to emit a light pulse sequence;
at least three optical elements configured to change transmission directions of the light pulse sequence; and
a control circuit configured to control a scanning field of view (FOV) by performing at least one of:
controlling at least one of a scan pattern, a position, or a scan density by controlling rotation speeds of the at least three optical elements; or
controlling an extension direction of the scanning FOV by controlling initial phases of the at least three optical elements.

19. The apparatus according to claim 18, wherein:
the at least three optical elements include three light refraction elements arranged side by side along an exit optical path of the light pulse sequence; and
each of the light refraction elements includes a light exit surface and a light entrance surface that are non-parallel to each other.

20. The apparatus according to claim 18, wherein:
the at least three optical elements rotate around a same rotation axis;
rotation axes of the at least three optical elements are parallel to each other; or
an angle between the rotation axes of any two adjacent optical elements of the at least three optical elements is less than 10°.
